(19) United States
(12) Patent Application Publication
(10) Pub. No.: US 2026/0317580 A1
(43) Pub. Date: Oct. 15, 2026

(54) POLYIMIDES AND PROCESSES OF MAKING AND USING SAME

(71) Applicant: Government of the United States as represented by the Secretary of the Air Force, Wright-Patterson AFB, OH (US)

(72) Inventors: Zhenning Yu, Beavercreek, OH (US); Christopher A. Crouse, Waynesville, OH (US); Matthew L. Baczkowski, Dayton, OH (US)

(21) Appl. No.: 19/169,229

(22) Filed: Apr. 3, 2025

(51) Int. Cl. C09D 179/08; C08G 73/10; C08K 7/18

(52) U.S. Cl. CPC C09D 179/08; C08G 73/1067; C08K 7/18; C08K 2201/011

(57) ABSTRACT

The use of polyimides comprising substituted fluorene moiety containing diamine monomers is disclosed. Such polyimides are fully imidized. Such polymers needed not be processed at high temperatures, yet they can survive high temperatures. The disclosed polyimides can be applied at low temperatures using less-toxic solvents, yet such materials can survive high temperatures. Such polyimides can be used in applications such as a resin for preparation of polymer matrix composites, adhesion for joining multiple components and as binder component for a coating. Furthermore, the polyimide-based coating or composite can be used as a thermal insulation layer and/or electrical insulation layer for electronic packaging. Finally, as the disclosed polyimides are highly soluble, they can easily be recycled and/or reconfigured.

### RIGHTS OF THE GOVERNMENT

The invention described herein may be manufactured and used by or for the Government of the United States for all governmental purposes without the payment of any royalty.

### FIELD OF THE INVENTION

The present invention relates to a method of using polyimides derived from substituted fluorene moiety containing diamine monomers.

### BACKGROUND OF THE INVENTION

Protecting sensitive materials and electronic devices against thermal and/or electrostatic discharge damage while exposed or operating at elevated temperatures is increasingly important for aerospace and commercial applications. Current protective coatings must be applied at high temperatures to survive service temperatures of 200° C. or above. Current protective coatings employ a polymer having a high glass transition temperature, T_{g}, such as a polyimide. Traditionally, a polyimide coating, such as Kapton® enamels, is applied at the soluble polyamic acid stage. The solvents are typically non-aprotic organic solvents, such as dimethylacetamide (DMAc), 1-methyl-2-pyrrolidinone (NMP) or mixtures containing the said solvents. To achieve the final coating properties, the coating and the coated substrates must go through heating cycles for solvent removal and conversion of the polyamic acid to polyimide, which is known as the imidization. The imidization process limits the applications of such approach, as the substrates being protected must be able to survive the imidization process. The in-situ thermal imidization process is not suitable for coating of any heat sensitive objects including, but not limited to, nanoparticles, organic particulates, or heat sensitive electronics.

Applicants recognized that the source of the problems associated with the current polyimide materials that are used as coatings was that they were not fully imidized and lacked solution processability once imidized. Applicants also recognized by utilizing certain polyimides derived from substituted fluorene moiety containing diamine monomers, it is possible to create a processable polyimide solution that can be readily used, for example, as a binder in coating. Such polyimides provide enhanced solubility in low boiling point and/or less toxic solvents such as ethyl acetate and methyl ethyl ketone as they are fully imidized. Such polyimides need not be processed at high temperatures, yet they can survive/remain functional at temperatures that are 270° C. to 370° C. Thus, Applicants disclose herein a method of using polyimides derived from substituted fluorene moiety containing diamine monomers. The disclosed polyimides that are employed are fully imidized and comprise/are derived from substituted fluorene moiety containing diamine monomers. As a result, the disclosed polyimides can be applied at low temperatures using less-toxic solvents, yet such coatings can survive high temperatures. Such polyimides can be used in applications such as: a resin for preparation of polymer matrix composite, adhesive for joining multiple components and/or as a binder for coating. Furthermore, the such polyimide-based coating or composite can be used as a thermal insulation layer and/or electrical insulation layer for electronic packaging. Finally, as the disclosed polyimides are highly soluble, they can easily be recycled and/or reconfigured.

### SUMMARY OF THE INVENTION

The use of polyimides comprising substituted fluorene moiety containing diamine monomers is disclosed. Such polyimides are fully imidized. Such polymers needed not be processed at high temperatures, yet they can survive high temperatures. The disclosed polyimides can be applied at low temperatures using less-toxic solvents, yet such materials can survive high temperatures. Such polyimides can be used in applications such as a resin for preparation of polymer matrix composites, adhesive for joining multiple components and as binder component for a coating. Furthermore, the polyimide-based coating or composite can be used as a thermal insulation layer and/or electrical insulation layer for electronic packaging. Finally, as the disclosed polyimides are highly soluble, they can easily be recycled and/or reconfigured.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, explain the principles of the present invention.

FIG. 1. is an Overlay of Ultraviolet-Visible spectrum of polyimide, 6FDA-FDA, in THF; gold nano spheric particles in water and the composite film of polyimide with gold nano particles film.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

For purposes of this specification a fluorene moiety has the following structure

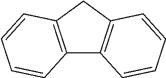 [SMILES: c1ccc2c(c1)Cc1ccccc1-2]

and an example of a substituted fluorene moiety containing diamine, 9,9-Bis(3-fluoro-4-aminophenyl)fluorene, CAS Registry Number: 127926-65-2, may have the following structure:

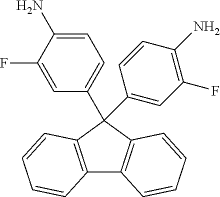 [SMILES: Nc1ccc(C2(c3ccc(N)c(F)c3)c3ccccc3-c3ccccc32)cc1F]

Processable polyimides with high glass transition temperature great than 270° C. are rare. Thermosetting polyimide resins are dominating players for the extreme aerospace and defense operating temperatures in the range of 260-371° C. (500-700° F.). The current state of art of high temperature polyimide resin is based on crosslinkable polyimide chemistry. P. M. Hergenrother et al taught us in United State U.S. Pat. No. 5,760,168, “Imide oligomers endcapped with phenylethynl phthalic anhydrides and polymers therefrom”, that crosslink chemistries enable higher polyimide service temperature. The above-mentioned patent also indicated that the oligomer exhibited poor solubility in DMAc as the imidized oligomer will precipitate out of reaction mixture. Typically, the crosslinking (curing) process is performed at high temperature and is a not a reversible process. Once the thermoset is made, it is impossible to reconfigure or reprocess the material. Hence, the disadvantages of thermosetting polyimide resins include: 1) the oligomeric polyimides are not soluble in most common solvents; thus composites must be prepared via melt compounding or must be prepared by solution compounding at soluble polyamic acid stage; 2) thermoset composites are not recyclable and reconfigurable; 3) the curing process must be carried out at high temperature (close to or above glass transition temperature of polyimide resin) which may not be suitable for preparation of a composite comprising thermally sensitive components. Hence, the thermosetting polyimide resin is not suitable to encapsulate temperature sensitive objects. The capability to prepare polyimide-based high temperature composite(s) in solution at mild temperature (e.g., room temperature) is highly desirable for many applications. From the recyclability and reconfigurability prospect, soluble polyimide resin is highly desirable. Recently Loon-Seng Tan, Zhenning Yu, et. al, disclosed in U.S. Pat. No. 11,296,726 B2, “Polyimide-gold-nanorod j-aggregates with broadened surface plasmonic resonance band and method of manufacture”, demonstrating that soluble polyimides can be used to prepare polyimide composites in solution. However, the patent application does not include any polyimide comprising diamines with fluorene moieties. Furthermore, the patent application only applied to composites made of polyimide with gold nanorods. This current invention provides a method to prepare highly soluble polyimide with glass transition temperature above 270° C. that demonstrate solubility in common organic solvents and a method to prepare the said polyimide with other components to form a coating or polymeric matrix composite. The practice of solution-based coating for industrial applications must also consider the solvent's chemical compatibility with the object or substrate being coated in addition to the solvent's life cycle impacts which include the solvent's safety, toxicity, waste disposal requirements and impact to environment. Raj Joshi R et. al in Journal of Pharmaceutical Research International, 2019, 28 (3) 1-28 mentioned that Pfizer's Medicinal Chemistry Solvent Selection Guide while discuss of common solvents and their toxicity. Based on the guide, the currently commonly used solvents for polyimide coating applications, such as DMAc and NMP, are not considered as desirable solvents. Examples of preferred organic solvents are ethyl acetate (EtOAc) and methylethylketone (MEK). Hence, polyimides with good solubility in a variety of organic solvents are increasingly important for aerospace or commercial applications. Organic soluble polyimides have previously been developed by many entities, such as LaRC-CP2™ (NASA), Ultem® (SABIC), and Matrimid®5218 (Huntsman). These polyimides provide a more expansive selection of soluble solvents in addition to DMAc and NMP. For example, LaRC-CP2 exhibits good solubility in dichloromethane (DMC), chloroform, and tetrahydrofuran (THF). Table 1 provides a summary of our solubility test results for 10 mg of polyimide in 1 mL each of the 15 commons solvents. Our evaluation indicates none of above-mentioned polyimides is soluble in EtOAc. Only LaRC-CP2 is soluble in MEK. Hence, there is urgent need to develop novel polyimides with better solubility in ester or ketone types of solvents.

TABLE 1
Solubility test results of LaRC-CP2 ™ (NASA), Ultem ® 1000
(SABIC), and Matrimid ®5218 (Huntsman).

| | Solubility at 20° C. (1 = soluble, 0 = not | | |
|---|---|---|---|
| | soluble, S = swelled, but not soluble) | | |
| Solvent | LaRC-CP2 ™ | Ultem ®1000 | Matrimid ®5218 |
| Chloroform | 1 | 1 | 1 |
| m-Cresol | 1 | 1 | 1 |
| Diethyl ether | 0 | 0 | 0 |
| Dimethyl sulfoxide | 1 | S | 1 |
| Ethanol | 0 | 0 | 0 |
| EtOAc | S | S | 0 |
| Hexanes | 0 | 0 | 0 |
| MEK | 1 | S | 0 |
| NMP | 1 | 1 | 1 |
| DCM | 1 | 1 | 1 |
| DMAc | 1 | 1 | 1 |
| Dimethylforamide | 1 | S | S |
| 2-Propanol | 0 | 0 | 0 |
| THF | 1 | S | 1 |
| Toluene | S | 0 | 0 |

For soluble polyimide used as high temperature coating binder, T_{g} is one of the important thermal properties. Said polymers can be used for long term at temperatures from 270° C. to 370° C.; and for a short time above 370° C. Ideally, the glass transition of the said polyimide is above 350° C. Of the above mentioned three commercially available soluble polyimides, only Matrimid® 5218 exhibits a T_{g} above 300° C. but less than 350° C. As taught by Langsam M. et al. in Journal of Polymer Science, Part A: Polymer Chemistry, 1993, 31, 900-921, polyimides made from 9H-Fluoren-9-ylidene bis(aniline) and (Hexafluoroisopropylidene)diphthalic (6FDA), exhibit glass transition temperatures as high as 355° C. As Moy, T. M et al. Polymer, 1993, 34, 819-824, disclosed that polyimide oligomer made from variety of anhydride with 4,4′-(9-Fluorenylidene) dianiline (FDA) is soluble in DMAc. Chun, B in Polymer, 1994, 4203-4206 disclosed polyimides made by condensation of FDA with 6FDA or bicyclo[2.2.21-oct-7-ene-2,3,5,6-tetracarboxylic dianhydride (BCDA) showing good solubility in DMAc, NMP, THF and chloroform, but not in EtOAc. Hence, fluorene moieties containing bis(aniline) monomer, such as FDA, enable the resultant polyimide a high T_{g} (300° C. or above) and good solubility in organic solvents. In the past, polyimide solubility evaluations were focused on solvents such as NMP, DMAc, pyridine, m-cresol, chloroform, THF; seldom ester containing solvents such as EtOAc or ketone-based solvents such as MEK were investigated. Our invention is focused on polyimide solubility in many common solvents, especially ester solvents such as EtOAc and ketone-based solvents such MEK.

Furthermore, our investigation also indicates, even by employing substituted FDA as monomers, the solubility of resultant polyimides in a specific solvent is not obviously guaranteed. For example, 4,4′-(2,7-difluoro-9H-fluorene-9,9-diyl)dianiline (FDA-27F) and 4,4′-(9H-fluorene-9,9-diyl)bis(2-fluoroaniline) (FDA-F) are isomeric species. Structure of FDA-F and isomeric structure of FDA-27F are shown below:

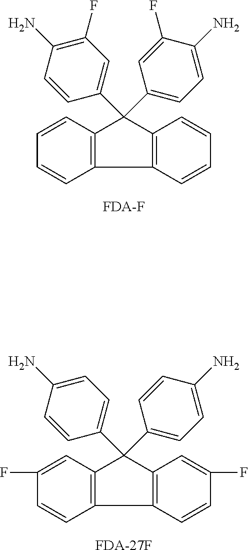

These two monomers were polymerized with 6FDA to form respective polyimides, which were named as 6FDA-FDA-27, and 6FDA-FDA-F respectively. The solubility test results of these two polyimides in 15 common solvents are shown in Table 2. Our testing results indicate that 6FDA-FDA-F is soluble in EtOAc and MEK, but 6FDA-FDA-27 is not soluble in above two solvents. Hence, this invention discloses a method to prepare polyimide with better solubility in common solvents other than alcohols and hydrocarbons is significant and not obvious.

TABLE 2
Solubility test result of 6FDA-FDA-F and 6FDA-FDA-27F

Solubility at 20° C. (1 = soluble, 0 = not
soluble, S = swelled, but not soluble)

| Solvent | 6FDA-FDA-27F | 6FDA-FDA-F |
|---|---|---|
| Chloroform | 1 | 1 |
| m-Cresol | 1 | 1 |
| Diethyl ether | 0 | 0 |
| Dimethyl sulfoxide | 1 | 1 |
| Ethanol | 0 | 0 |
| EtOAc | 0 | 1 |
| Hexanes | 0 | 0 |
| MEK | 0 | 1 |
| NMP | 1 | 1 |
| DCM | 1 | 1 |
| DMAc | 1 | 1 |
| Dimethyforamide | 1 | 1 |
| 2-Propanol | 0 | 0 |
| THF | 1 | 1 |
| Toluene | 0 | 0 |

In order to precisely control solubility in a specific organic solvent or solvent mixture, preferable ester- and/or ketone based solvent or solvent mixture, and at the same time keep the T_{g} of the resultant polyimide at 270° C. or above, this invention is focusing on two aspects of molecular engineering: 1) making substituted fluorene moieties containing diamines and applying such diamines to make solution processable high T_{g} polyimides, 2) tuning solubility via copolymerization of more than one diamines and/or more than one dianhydrides to achieve better solubility control in specific solvent or solvent mixture. A generic structure of fluorene moiety containing diamine is show as the following:

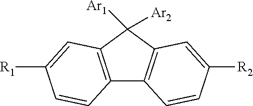

Brief description of the generic structure of the diamine, 9-Ar₁, 9-Ar₂, −2-R₁, 7-R₂-fluorene. The core of the diamine is 2,7-disubstituted fluorene moiety. There is an R₁ substitution at the 2 position and an R₂ substitution at the 7 positions. Ar₁ and Ar₂ at 9 positions are two amino containing aromatic groups. To precisely control the solubility of the resultant polyimide in a given solvent, Ar₁ and Ar₂ must be carefully chosen.

For any polyimide which is made using the condensation of dianhydride(s) and diamine(s), both monomers contribute to the solubility of the resultant polyimide. Tianyun Li et al in RSC Advances, 2017, 7, 40996-41003 gave insight that polyimides made with 6FDA and exhibit solubility in THF and partially solubility in hot acetone. Polyimides made with 4,4′-Oxydiphthalic anhydride (ODPA) are soluble in THF but not in Acetone. Compared to polyimides with the same diamine, the polyimide made with 6FDA exhibits higher T_{g} than those made with ODPA. Hence, 6FDA is the most preferable dianhydride for making polyimides with high solubility in organic solvents and high T_{g}.

For specific application, the desirable polyimide solubility may be need fine-tuned to meet specific solvent and solubility requirement without scarifying high T_{g} property. One way this can be achieved is through combining more than on diamine or dianhydride resulting in a copolymer. Jinfeng Hu et al in High Performance Polymers 2019, 31, 1272-1279 describes the copolymerization of OPDA and 3,3′,4,4′-Biphenyltetracarboxylic dianhydride (BPDA) with 4,4′-(1,3-phenylenedioxy)dianiline, it was possible to make co-polyimide exhibit good solubility in aprotic solvents and at the same time maintaining good thermal performance. Hence, it is equally important to develop a new diamine that has good solubility while maintaining high thermal performances or achieve a similar performance via co-polymerization. Copolymerization may serve as an additional tool for fine tuning the final product's properties. Using said polyimide to preparation of polyimide composite can be carried by solution blending process as the following: Method 1: Combining the said polyimide in a solution with any other components of the composites by mixing, then, remove the solvent by evaporation of the solvent vacuum drying process; or by convection drying at room temperature or elevated temperature; Method 2: Combining the said polyimide solution with any other components of the composites by mixing, then adding a poor solvent to the polyimide mixture, until polyimide and other components co-precipitate at the same time. The precipitation is harvested via common liquid/solids separation methods such as filtration or centrifugation; Method 3: Suspending or dissolving other composite component(s) in a poor solvent to polyimide, then combining the said solution or suspension with the polyimide solution to induce a co-precipitation. The precipitation is harvested via common liquid/solids separation methods such as filtration or centrifugation. Further drying can be done by vacuum drying, convection drying at room temperature or elevated temperature.

One of the important aspects of polymers soluble in common, low toxic solvents is that it can maintain good thermal properties and processability with limited environmental and health impacts. The good solubility enables the said polyimide to be reused, recycled or reconfigured through the re-dissolving process.

### Compositions and Articles

In this paragraph Applicants disclose a composition comprising one or more solvents, a polyimide polymer comprising a repeat unit having the following formula:

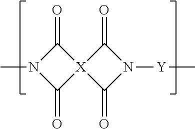

wherein X has one of the following structures:

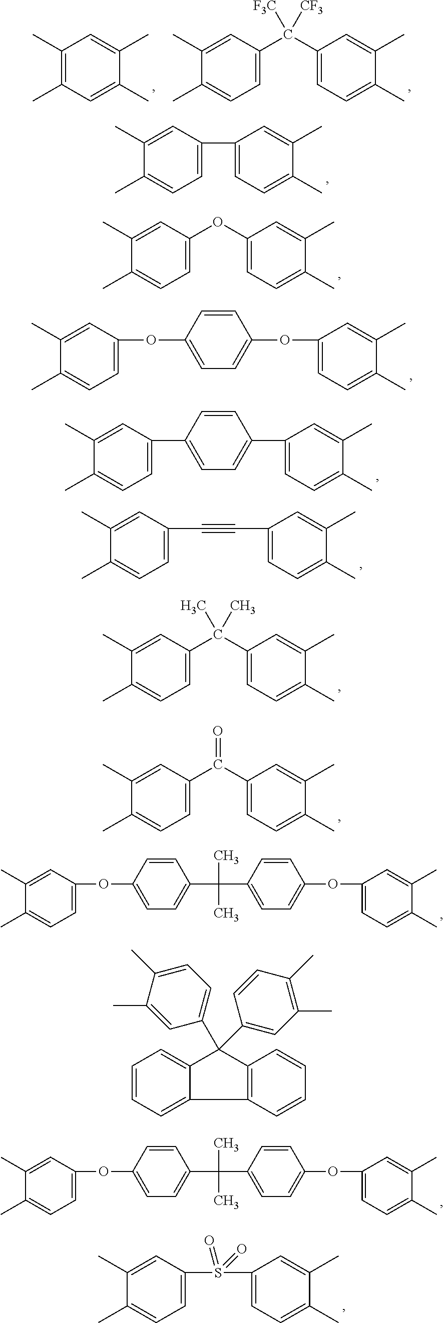

wherein Y has one of the following structures:

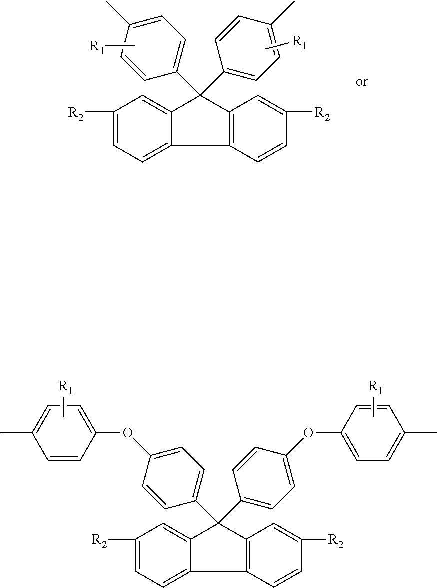

wherein each R₁, and R₂ are independently H, F, CH₃, CF₃, Cl or Br; and one or more optional adjuncts, said composition being a coating, an adhesive or a prepreg solution; preferably said one or more solvents are selected from the group consisting of 1-methyl-2-pyrrolidinone, dimethylacetamide, dimethylformamide, dimethyl sulfoxide, tetrahydrofuran, ethylene glycol monomethyl ether, ethylene glycol butyl ether, ethylene glycol ethyl ether, 2-butanone, acetone, methyl isobutyl ketone, methyl amyl ketone, cyclohexanone, isophorone and mixtures thereof, ethyl acetate, ethylene glycol monoethyl ether acetate, n-butyl acetate, isobutyl acetate; more preferably said one or more solvents are selected from the group consisting of tetrahydrofuran, ethylene glycol butyl ether, ethylene glycol ethyl ether, 2-butanone, acetone, methyl isobutyl ketone, methyl amyl ketone, cyclohexanone, isophorone, ethyl acetate, n-butyl acetate, isobutyl acetate and mixtures thereof, most preferably said one or more solvents are selected from the group consisting of 2-butanone, methyl isobutyl ketone, methyl amyl ketone, cyclohexanone, isophorone, ethyl acetate, n-butyl acetate, isobutyl acetate and mixtures thereof.

In this paragraph Applicants disclose the composition of the previous paragraph wherein said polyimide polymer comprise one or more functional groups, preferably said functional groups are selected from the group consisting of a hydroxy moiety, a vinyl moiety, an acrylic moiety, a methacrylic moiety, an epoxy moiety, a phenylethynyl moiety and mixtures thereof.

In this paragraph Applicants disclose the composition of the previous two paragraphs wherein said polyimide polymer has a weight percentage of repeat units, based on total polyimide polymer, of from about 40% to about 99%, preferably said polyimide polymer has a weight percentage of repeat units, based on total polyimide polymer, of from about 50% to about 99%, most preferably said polyimide polymer has a weight percentage of repeat units, based on total polyimide polymer, of from about 70% to about 99%.

In this paragraph Applicants disclose the composition of the previous three paragraphs wherein said polyimide polymer comprises one or more functional groups selected from the group consisting of a hydroxy moiety, a vinyl moiety, an acrylic moiety, a methacrylic moiety, an epoxy moiety, a phenylethynyl moiety and mixtures thereof, said functional groups being present in said polyimide polymer, based on total polyimide polymer weight, in a range of from about 0.5% to about 60%, preferably said functional groups being present in said polyimide polymer, based on total polyimide polymer weight, in a range of from about 1% to 40%, most preferably said functional groups being present in said polyimide polymer, based on total polyimide polymer weight, in a range of from about 2% to 20%.

In this paragraph Applicants disclose the composition of the previous four paragraphs wherein said composition comprises an adjunct material, said adjunct material comprising a reinforcing filler, a dye, a pigment, a photo radical initiator, a thermal initiator, photo cationic initiator salt, photo anionic initiator salt, and/or an inorganic salt.

In this paragraph Applicants disclose the composition of the previous paragraph wherein said reinforcing filler comprises chopped carbon fiber, carbon fiber fabric, chopped glass fiber, glass fiber fabric, metal oxide particulates, metal particulates, hollow ceramic or glass particulates to include glass microspheres, and/or particulates of energetic materials, said photo radical initiator is selected from the group consisting of 2,4,6-trimethylbenzoyldiphenylphosphine oxide; bis(2,4,6-trimethylbenzoyl)phenylphosphine oxide; bis(2-ethylhexyl)phosphine oxide; phenyl[bis(2-phenylethyl)]phosphine oxide and mixtures thereof, said thermal initiator is selected from the group consisting of azobisisobutyronitrile; benzoyl peroxide; 2,2-bis(tert-butylperoxy)butane; 1,1-bis(tert-butylperoxy)-3,3,5-trimethylcyclohexane; tert-butyl hydroperoxide; 2,4-pentanedione peroxide; 2,5-bis(tert-butylperoxy)-2,5-dimethylhexane and mixtures thereof, said inorganic salt is selected from the group consisting of iron (III) chloride, nickel chloride, copper (II) chloride, cobalt (III) chloride, iron (III) bromide, nickel bromide, cobalt (III) bromide, palladium chloride, palladium acetate and mixtures thereof, said cationic photo initiator salt is selected from the group consisting of bis(4-tert-butylphenyl)iodonium hexafluorophosphate, 2-(1,3-benzodioxol-5-yl)-4,6-bis(trichloromethyl)-1,3,5-triazine, bis(4-tert-butylphenyl)iodonium tetrafluoroborate, bis[4-(tert-butyl)phenyl]iodonium tetra(nonafluoro-tert-butoxy)aluminate, bis(4-tert-butylphenyl)iodonium nonafluoro-1-butanesulfonate, bis(4-tert-butylphenyl)iodonium hexafluoroantimonate, bis(4-tert-butylphenyl)iodonium chloride, diphenyliodonium hexafluoroarsenate, nitrobenzenediazonium tetrafluoroborate, cyclopentadienyliron (ii) hexafluorophosphate, and mixtures thereof and said anionic photo imitator salt is selected from the group consisting of 2-(9-oxoxanthen-2-yl)propionic acid 1,5,7-triazabicyclo[4.4.0]dec-5-ene salt, 2-(9-oxoxanthen-2-yl)propionic acid 1,5-diazabicyclo[4.3.0]non-5-ene salt, 2-(9-oxoxanthen-2-yl)propionic acid 1,8-diazabicyclo[5.4.0]undec-7-ene salt, and mixtures thereof. Particulate fillers include both nanometer and/or micrometer sizes, agnostic to aspect ratio; the size of the particulates is typically from about 0.001 micrometers to about 500 micrometers.

In this paragraph Applicants an article comprising a composition according to any of the previous six paragraphs, preferably said article is an electronic chip or electronic circuit board

In this paragraph Applicants disclose an automobile, ship, rocket, airplane, spacecraft or satellite comprising the article of the previous paragraph.

### Test Method

For purposes of this specification the glass transition temperature of a polymer should be determined by differential scanning calorimetry (DSC), using a TA Discovery DSC 2500 or equivalent under nitrogen atmosphere with a heating scan rate of 10° C./min.

For purposes of this specification the average size of particles should be determined by Dynamic Light Scattering (DLS) analyzer using a Microtrac Nanotrac Wave II Zeta or equivalent. Alternative average size of particle should be determined by Scanning electron microscopy using a Thermo Fisher Scientific Apreo C Scanning electron microscope or equivalent, operating at accelerating voltage of 10 kV and probe current of 0.10 nA with a working distance of 10 mm.

### EXAMPLES

Example 1 Diamine monomer FDA-F (CAS Registry Number: 127926-65-2) can be made via condensation chemistry but also can be purchased from a commercial source such as Tokyo Chemical Industry Co. Ltd., 9211 North Harborgate StreetPortland, OR 97203, U.S.A.

Example 2 Polyimide 6FDA-FDA-F, made by condensation of 6FDA (CAS Registry Number: 1107-00-2, 6FDA) with FDA-F (CAS Registry Number: 127926-65-2)

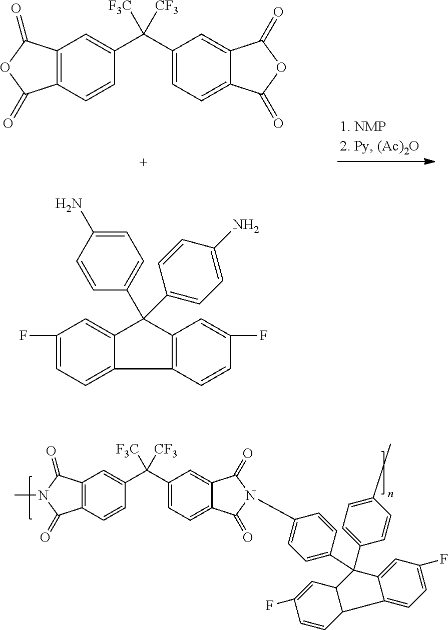

To a 100 mL round bottom flask equipped with stir bar and nitrogen inlet, 1.5377 g (4.000 mmol) of FDA-F and 13 mL anhydrous were charged. The mixture was stirred under nitrogen until all FDA-F was dissolved in NMP. To the mixture, 1.7770 g (4.000 mmol) 6FDA was added. The mixture was stirred at room temperature for 18 hours. Then, to the mixture, 4 mL anhydrous pyridine and 4.8 mL acetic acid anhydride were charged. After the mixture stirred at room temperature for additional 18 hours. The mixture was poured slowly into 200 mL 2-propanol. Solids were harvested via filtration as polyimide. The polyimide was air convection dried, and further dried under 0.5 torr vacuum at 160° C. for 24 hours. The glass transition of polyimide 6FDA-FDA-F was determined by DSC as 385° C. The polyimide 6FDA-FDA-F was soluble in EtOAc and MEK.

### Example 3 Synthesis of Polyimide 6FDA-FDA-27F, Made by Condensation of 6FDA with FDA-27F (CAS Registry Number: 2392025-45-3)

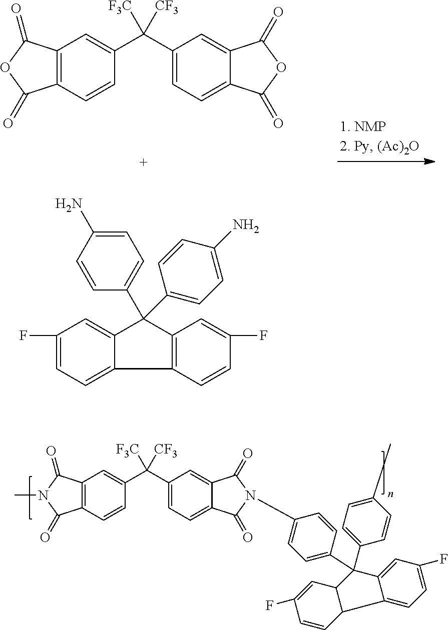

To a 100 mL round bottom flask equipped with stir bar and nitrogen inlet, 0.3941 g (1.000 mmol) of FDA-27F and 8 mL anhydrous were charged. The mixture was stirred under nitrogen until all FDA-27F was dissolved in NMP. To the mixture, 0.8885 g (1.000 mmol) 6FDA was added. The mixture was stirred at room temperature for 18 hours. Then, to the mixture, 1 mL anhydrous pyridine and 1.2 mL acetic acid anhydride were charged. After the mixture stirred at room temperature for additional 18 hours. The mixture was poured slowly into 200 mL 2-propanol. Solids were harvested via filtration as polyimide. The polyimide was air convection dried, and further dried under 0.5 torr vacuum at 160° C. for 24 hours. The glass transition of polyimide 6FDA-FDA-27F determined by DSC as 393° C. The polyimide 6FDA-FDA-27 is not soluble in MEK nor in EtOAc.

### Example 4 Synthesis of Polyimide, 6FDA-FDA, Made by Condensation of 6DFA with FDA (CAS Registry Number: 15499-84-0)

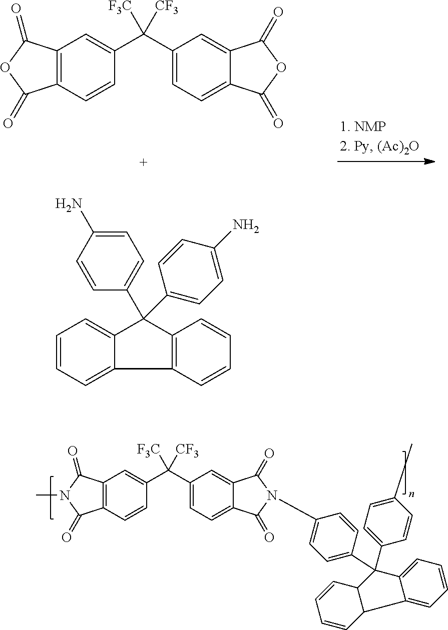

To a 200 mL round bottom flask equipped with stir bar and nitrogen inlet, 3.4844 g (10.000 mmol) of FDA and 16 mL anhydrous were charged. The mixture was stirred under nitrogen until all FDA was dissolved in NMP. To the mixture, 4.4424 g (10.000 mmol) 6FDA was added. The mixture was stirred at room temperature for 18 hours. Then, to the mixture, 10 mL anhydrous pyridine and 12.4 mL acetic anhydride were charged. After the mixture stirred at room temperature for additional 18 hours. The mixture was poured slowly into 600 mL 2-propanol. Solids were harvested via filtration as polyimide. The polyimide was air convectional dried, and further dried under 0.5 torr vacuum at 160° C. for 24 hours. The glass transition of polyimide 6FDA-FDA determined by DSC as 392° C. The polyimide 6FDA-FDA is not soluble in EtOAc but swollen in MEK.

### Example 5 Preparation of Composite of Gold Spheric Nanoparticles with Polyimide (6FDA-FDA) by Method 3 and Reconfigure the Composite to a Thin Film

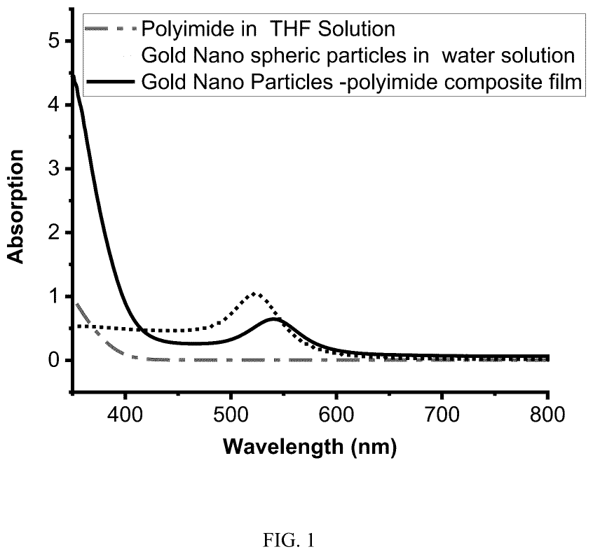

To a 0.1 grams of polyimide 6FDA-FDA in 10 mL tetrahydrofuran (THF) solution, 1.0 mL gold nano spheric particles solution was charged, which has plasmonic absorption at 523 nm was around 1. The precipitation was harvested, via filtration, then air convection dried. The composite is resolved in 4 mL THF solution, then cast onto a 2″×2″ glass slide inside an oven to control THE evaporation rate. After drying at room temperature for 2 days and further vacuum drying for additional two days. The composite film was peeled off from glass slide to give a free-standing thin film with average thickness about 30 micrometers. The ultraviolet-visible spectrum of film was compared to that of gold nanos spheric particles solution shown in FIG. 1, which demonstrate the composite powder is successfully reconfigured into thin film.

Example 6 Co-polyimide ODPA-FDA-F-co-6FDA-FDA-F, made by a mixture of ODPA and 6FDA condensation with FDA-F, containing approximate 54.4% by weight of 6FDA-FDA-F.

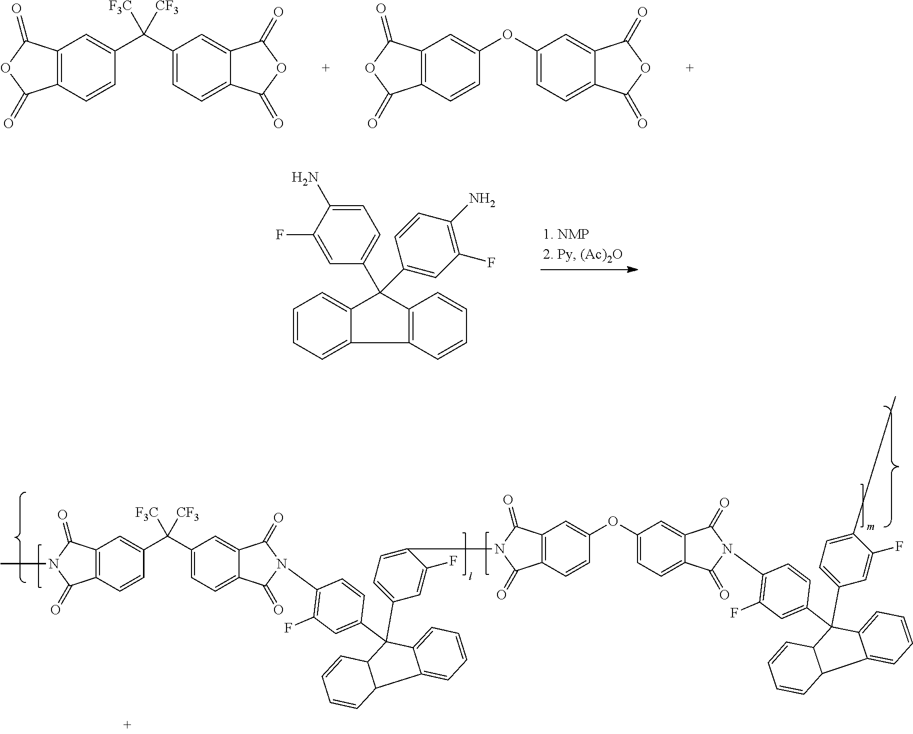

To a 100 mL round bottom flask equipped with stir bar and nitrogen inlet, 1.5377 g (4.000 mmol) of FDA-F and 15 mL anhydrous were charged. The mixture was stirred under nitrogen until all FDA-F was dissolved in NMP. To the mixture, 0.6204 g (2.000 mmol) ODPA, and 0.8885 (2.000 mmol) 6FDA were charged. The mixture was stirred at room temperature for 18 hours. Then, to the mixture, 0.8 mL anhydrous pyridine and 0.9 mL acetic anhydride were charged. The mixture was heated to 80° C. and held for 6 hours. After cooled to room temperature, the mixture was poured slowly into 600 mL 2-propanol. Solids were harvested via filtration as polyimide. The polyimide was air convectional dried, and further dried under 0.5 torr vacuum at 160° C. for 24 hours. The glass transition of this co-polyimide, ODPA-FDA-F-co-6FDA-FDA-F, determined by DSC as 362° C.

Example 7 Co-polyimide 6FDA-FDA-co-6FDA-FDA-F, made by condensation of 6FDA with a mixture of FDA and FDA-F.

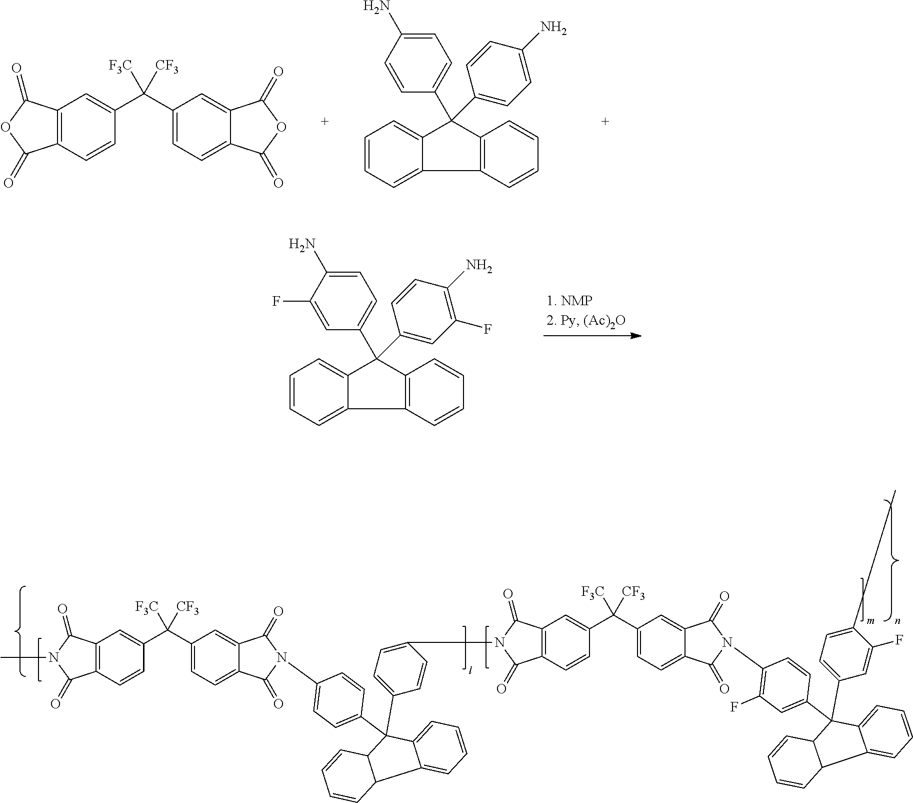

To a 100 mL round bottom flask equipped with stir bar and nitrogen inlet, 0.7689 g (2.000 mmol) of FDA-F, 0.6969 g (2.000 mmol) FDA and 12 mL anhydrous were charged. The mixture was stirred under nitrogen until all diamines were dissolved in NMP. To the mixture, 1.7770 (4.000 mmol) 6FDA were charged. The mixture was stirred at room temperature for 18 hours. Then, to the mixture, 0.8 mL anhydrous pyridine and 0.9 mL acetic anhydride were charged. The mixture was heated to 80° C. and held for 6 hours. After cooled to room temperature, the mixture was poured slowly into 600 mL 2-propanol. Solids were harvested via filtration as polyimide. The polyimide was air convectional dried, and further dried under 0.5 torr vacuum at 160° C. for 24 hours. The glass transition of this co-polyimide, 6FDA-FDA-co-6FDA-FDA-F, determined by DSC as 377° C.

### Example 8 Solubility Comparison of Homo and Copolymers

Four homopolymers were made employing either ODPA or 6FDA as the dianhydride with FDA or FDA-F as the diamine. Two copolymers were made, ODPA-FDA-F-co-6FDA-FDA-F is the co-polyimide made with ODPA and a 1:1 ratio of FDA and FDA-F. 6FDA-FDA-co-6FDA-FDA-F is the co-polyimide. Compared to homopolymer ODPA-FDA-F, the solubility of copolymer ODPA-FDA-F-co-6FDA-FDA-F in MEK increases; the solubility in EtOAc decreases, compared to homopolymer 6FDA-FDA-F. For co-polymer 6FDA-FDA-co-6FDA-FDA-F, the solubility in MEK and EtOAc increases compared to homopolymer 6FDA-FDA but decreases compared to 6FDA-FDA. This example shows the art of fine-tuning solubility in specific solvents by co-polymerization.

| | | T_{g} | Solubility | | |
|---|---|---|---|---|---|
| Polyimide ID | Polymer type | (° C.) | THF | MEK | EtOAc |
| 6FDA-FDA-F | homopolymer | 385 | Y | Y | Y |
| 6FDA-FDA | homopolymer | 392 | Y | S | N |
| ODPA-FDA-F | homopolymer | 359 | Y | N | N |
| ODPA-FDA | homopolymer | 375 | S | N | N |
| ODPA-FDA-F- | copolymer | 362 | Y | Y | S |
| co-6FDA-FDA-F | | | | | |
| 6FDA-FDA-co- | copolymer | 377 | Y | Y | S |
| 6FDA-FDA-F | | | | | |

Y = soluble, form homogenous solution at a concentration of 10 mg of polyimide in 1 mL the solvent
N = insoluble, polymer stays as solids state in the solvent
S = swell, but not soluble, there is phase separation

What is claimed is:

1. A composition comprising one or more solvents, a polyimide polymer comprising a repeat unit having the following formula: 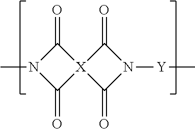
wherein X has one of the following structures: 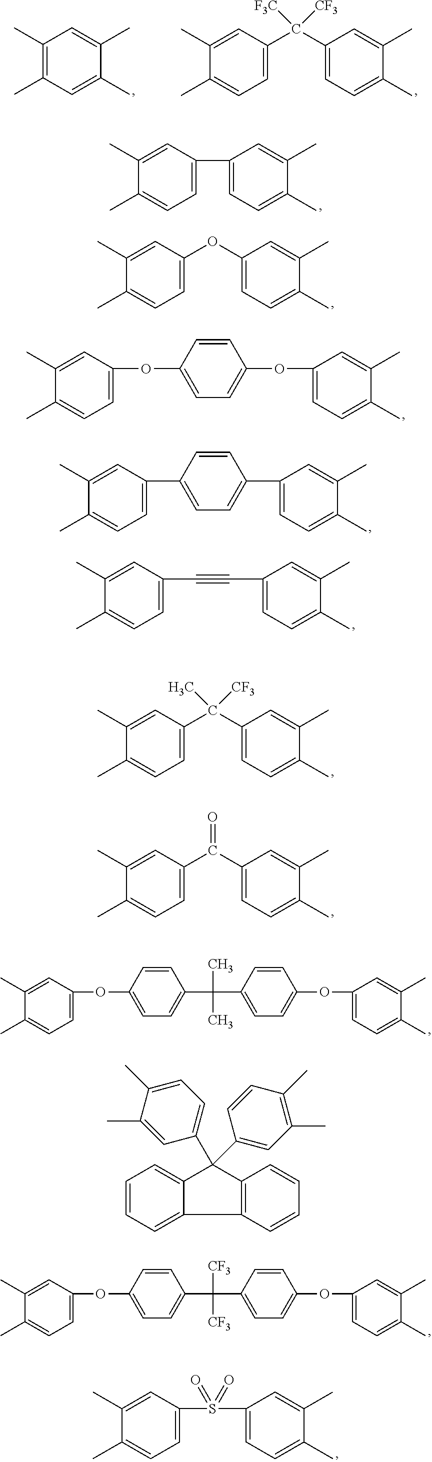
wherein Y has one of the following structures: 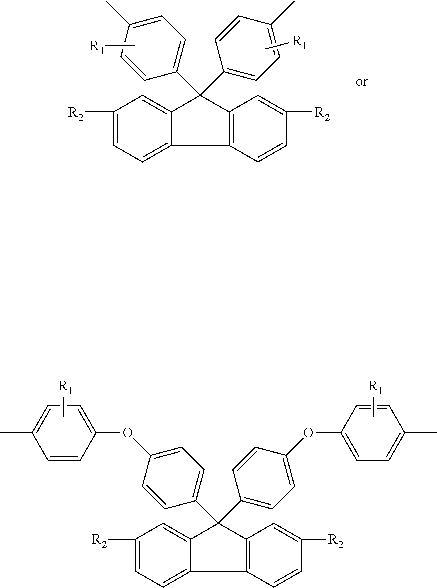
wherein each R₁, and R₂ are independently H, F, CH₃, CF₃, Cl or Br; and one or more optional adjuncts, said composition being a coating, an adhesive or a prepreg solution.

2. The composition of claim 1 wherein said one or more solvents are selected from the group consisting of 1-methyl-2-pyrrolidinone, dimethylacetamide, dimethylformamide, dimethyl sulfoxide, tetrahydrofuran, ethylene glycol monomethyl ether, ethylene glycol butyl ether, ethylene glycol ethyl ether, 2-butanone, acetone, methyl isobutyl ketone, methyl amyl ketone, cyclohexanone, isophorone and mixtures thereof.

3. The composition of claim 1 wherein said one or more solvents are selected from the group consisting of tetrahydrofuran, ethylene glycol butyl ether, ethylene glycol ethyl ether, 2-butanone, acetone, methyl isobutyl ketone, methyl amyl ketone, cyclohexanone, isophorone, ethyl acetate, n-butyl acetate, isobutyl acetate and mixtures thereof.

4. The composition of claim 1 wherein said one or more solvents are selected from the group consisting of 2-butanone, methyl isobutyl ketone, methyl amyl ketone, cyclohexanone, isophorone, ethyl acetate, n-butyl acetate, isobutyl acetate and mixtures thereof.

5. The composition of claim 1 wherein said polyimide polymer comprise one or more functional groups.

6. The composition of claim 5 wherein said functional groups are selected from the group consisting of a hydroxy moiety, a vinyl moiety, an acrylic moiety, a methacrylic moiety, an epoxy moiety, a phenylethynyl moiety and mixtures thereof.

7. The composition of claim 1, wherein said polyimide polymer has a weight percentage of repeat units, based on total polyimide polymer, of from about 40% to about 99%.

8. The composition of claim 7, wherein said polyimide polymer has a weight percentage of repeat units, based on total polyimide polymer of from about 50% to about 99%.

9. The composition of claim 8, wherein said polyimide polymer has a weight percentage of repeat units, based on total polyimide polymer of from about 70% to about 99%.

10. The composition of claim 1 wherein said polyimide polymer comprises one or more functional groups selected from the group consisting of a hydroxy moiety, a vinyl moiety, an acrylic moiety, a methacrylic moiety, an epoxy moiety, a phenylethynyl moiety and mixtures thereof, said functional groups being present in said polyimide polymer, based on total polyimide polymer weight, in a range of from about 0.5% to about 60%.

11. The composition of claim 10 wherein said functional groups are present in said polyimide polymer, based on total polyimide polymer weight, in a range of from about 1% to 40%.

12. The composition of claim 11 wherein said functional groups are present in said polyimide polymer, based on total polyimide polymer weight, in a range of from about 2% to 20%.

13. The composition of claim 1, said composition having a polyimide solid content, based on total composition weight, of from about 0.5% to about 50%.

14. The composition of claim 13, said composition having a polyimide solid content, based on total composition weight, of from about 1% to about 40%.

15. The composition of claim 14, said composition having a polyimide solid content, based on total composition weight of from about 2% to about 20%.

16. The composition of claim 1 comprising an adjunct material, said adjunct material comprising a reinforcing filler, a dye, a pigment, a photo radical initiator, a thermal initiator, photo cationic initiator salt, photo anionic initiator salt, and/or an inorganic salt.

17. The composition of claim 16 wherein said reinforcing filler comprises chopped carbon fiber, carbon fiber fabric, chopped glass fiber, glass fiber fabric, metal oxide particulates, metal particulates, hollow ceramic or glass particulates to include glass microspheres, and/or particulates of energetic materials.

18. The composition of claim 16 wherein said photo radical initiator is selected from the group consisting of 2,4,6-trimethylbenzoyldiphenylphosphine oxide; bis(2,4,6-trimethylbenzoyl)phenylphosphine oxide; bis(2-ethylhexyl)phosphine oxide; phenyl[bis(2-phenylethyl)]phosphine oxide and mixtures thereof.

19. The composition of claim 16 wherein said thermal initiator is selected from the group consisting of azobisisobutyronitrile; benzoyl peroxide; 2,2-bis(tert-butylperoxy)butane; 1,1-bis(tert-butylperoxy)-3,3,5-trimethylcyclohexane; tert-butyl hydroperoxide; 2,4-pentanedione peroxide; 2,5-bis(tert-butylperoxy)-2,5-dimethylhexane and mixtures thereof.

20. The composition of claim 16 wherein said inorganic salt is selected from the group consisting of iron (III) chloride, nickel chloride, copper (II) chloride, cobalt (III) chloride, iron (III) bromide, nickel bromide, cobalt (III) bromide, palladium chloride, palladium acetate and mixtures thereof.

21. The composition of claim 16 wherein said cationic photo initiator salt is selected from the group consisting of bis(4-tert-butylphenyl)iodonium hexafluorophosphate, 2-(1,3-benzodioxol-5-yl)-4,6-bis(trichloromethyl)-1,3,5-triazine, bis(4-tert-butylphenyl)iodonium tetrafluoroborate, bis[4-(tert-butyl)phenyl]iodonium tetra(nonafluoro-tert-butoxy)aluminate, bis(4-tert-butylphenyl)iodonium nonafluoro-1-butanesulfonate, bis(4-tert-butylphenyl)iodonium hexafluoroantimonate, bis(4-tert-butylphenyl)iodonium chloride, diphenyliodonium hexafluoroarsenate, nitrobenzenediazonium tetrafluoroborate, cyclopentadienyliron (ii) hexafluorophosphate, and mixtures thereof.

22. The composition of claim 16 wherein said anionic photo imitator salt is selected from the group consisting of 2-(9-oxoxanthen-2-yl)propionic acid 1,5,7-triazabicyclo[4.4.0]dec-5-ene salt, 2-(9-oxoxanthen-2-yl)propionic acid 1,5-diazabicyclo[4.3.0]non-5-ene salt, 2-(9-oxoxanthen-2-yl)propionic acid 1,8-diazabicyclo[5.4.0]undec-7-ene salt, and mixtures thereof.

23. An article comprising a composition according to claim 1.

24. The article of claim 23, said article being an electronic chip or electronic circuit board.

25. An automobile, ship, rocket, airplane, spacecraft or satellite comprising the article of claim 23.
